(19) United States
(12) Patent Application Publication
(10) Pub. No.: US 2024/0429795 A1
(43) Pub. Date: Dec. 26, 2024

(54) SYSTEM FOR PROCESSING A HAIRPIN FOR A STATOR

(71) Applicants: HYUNDAI MOTOR COMPANY, Seoul (KR); KIA CORPORATION, Seoul (KR)

(72) Inventor: Tae Kyun An, Hwaseong-si (KR)

(73) Assignees: HYUNDAI MOTOR COMPANY, Seoul (KR); KIA CORPORATION, Seoul (KR)

(21) Appl. No.: 18/494,004

(22) Filed: Oct. 25, 2023

(30) Foreign Application Priority Data
Jun. 23, 2023 (KR) 10-2023-0081291

(51) Int. Cl. H02K 15/04; B65G 47/90

(52) U.S. Cl. CPC H02K 15/0421; B65G 47/90

(57) ABSTRACT

A system for processing a hairpin for a stator includes an alignment part having a pre-inserting jig configured to perform a pre-inserting (pre-alignment) process on a hairpin, and a cartridge stock configured to store a plurality of different hairpin cartridges. A hairpin cartridge of the plurality of different hairpin cartridges is configured to supply the hairpin to the pre-inserting jig. The hairpin processing system also includes a cartridge transfer loader configured to selectively transfer the hairpin cartridge from the cartridge stock to the alignment part. As a result, the hairpin processing system advantageously simplifies the structure and treatment process of processing a hairpin of a stator and improves the productivity and production efficiency.

### CROSS-REFERENCE TO RELATED APPLICATION

This application claims priority to and the benefit of Korean Patent Application No. 10-2023-0081291, filed on Jun. 23, 2023, the entire contents of which are incorporated herein by reference.

### TECHNICAL FIELD

The present disclosure relates to a system for processing a hairpin for a stator, and more particularly, to a system for processing a hairpin for a stator capable of simplifying the structure and manufacturing process and improving the productivity and production efficiency.

### BACKGROUND ART

A hybrid vehicle or an electric vehicle, which is called an environmentally friendly vehicle, generates driving power using an electric motor (hereinafter, referred to as a ‘drive motor’) that obtains rotational force from electrical energy.

In general, the drive motor includes a stator coupled to a housing and a rotor rotatably disposed in the stator with a predetermined air gap from the stator.

The stator includes stator cores provided by stacking electrical steel sheets, and stator coils wound around slots of the stator cores.

Recently, a method of using a hairpin (also called a flat coil or an angular copper wire) as a stator coil has been proposed to increase the output of the motor and reduce the size of the motor.

Unlike an annular coil in the related art having a circular cross-section, the hairpin has an angular cross-section (e.g., a quadrangular cross-section). A hairpin having an angular cross-section can advantageously minimize a dead space (dead zone) in a slot of the stator and maximize the space of the stator coil.

The hairpin supplied to a cartridge (hairpin supply cartridge) is transferred to a pre-inserting jig by a robot (or loader), subjected to a pre-inserting process, and then inserted into a stator core.

However, in the related art, facilities (e.g., hairpin cartridges) for processing (supplying and transferring) the hairpins need to be independently provided in different spaces (or different production lines) depending on the types of hairpins (e.g., sizes of the hairpins). As a result, problems may occur in which the spatial utilization and degree of design freedom are constrained, and the productivity and production efficiency are degraded.

Therefore, recently, various studies have been conducted to simplify the structure and treatment process of the hairpin processing system and improve the productivity and production efficiency, but the study results are still insufficient.

### SUMMARY

The present disclosure has been made in an effort to provide a system for processing a hairpin for a stator (e.g., a hairpin processing system) capable of simplifying the structure and treatment process and improving the productivity and production efficiency.

In particular, the present disclosure has been made in an effort to handle various types of hairpins without additional facilities and production lines.

Among other things, the present disclosure has been made in an effort to process different types of hairpins by selectively changing hairpin cartridges in a single production line.

The present disclosure has also been made in an effort to improve the efficiency of a pre-inserting process for the hairpin, shorten the amount of time required to perform the pre-inserting process on the hairpin, and improve the production quality.

The objects to be achieved by the embodiments of the present disclosure are not limited to the above-mentioned objects, but also include objects or effects that may be understood from the solutions or embodiments described below.

To achieve the above-mentioned objects of the present disclosure, an embodiment of the present disclosure provides a system for processing a hairpin for a stator. The hairpin processing system includes: an alignment part having a pre-inserting jig configured to perform a pre-inserting (pre-alignment) process on a hairpin. The hairpin processing system also includes a cartridge stock configured to store a plurality of different hairpin cartridges. A hairpin cartridge of the plurality of different hairpin cartridges is configured to supply the hairpin to the pre-inserting jig. Additionally, the hairpin processing system includes a cartridge transfer loader configured to selectively transfer the hairpin cartridge from the cartridge stock to the alignment part.

As a result, the hairpin processing system simplifies the structure and treatment process of the hairpin and improves the productivity and production efficiency.

In other words, in the related art, facilities (e.g., hairpin cartridges) for processing (supplying and transferring) the hairpins need to be independently provided in different spaces (or different production lines) depending on the types of hairpins (e.g., sizes of the hairpins). As a result, a problem occurs in which the spatial utilization and degree of design freedom are constrained, and the productivity and production efficiency are degraded.

In contrast, according to the embodiment of the present disclosure, the hairpin cartridge may be selectively replaced depending on the type of hairpin (the type of motor), such that various types of hairpins may be handled (the pre-inserting process may be performed on the hairpin) in the single production line without additional facilities and production lines. Therefore, it is possible to obtain an advantageous effect of improving the spatial utilization and degree of design freedom and improving the productivity and production efficiency.

For reference, in the embodiment of the present disclosure, the pre-inserting of the hairpin may be defined as a process of aligning the hairpin at an exact position (target position) and in an exact posture by transferring the hairpin to the pre-inserting jig and inserting the hairpin into the pre-inserting jig before inserting the hairpin, which is supplied to the hairpin supply cartridge, into a slot (not illustrated) of the stator core.

According to an embodiment of the present disclosure, the plurality of hairpin cartridges may be provided to supply different types of hairpins to the pre-inserting jig.

According to another embodiment of the present disclosure, the alignment part may include a transfer part configured to transfer the pre-inserting jig along a preset route.

According to an embodiment of the present disclosure, the hairpin processing system may include a base member provided on the alignment part. Additionally, the hairpin cartridge may be seated on the base member.

According to an embodiment of the present disclosure, the hairpin processing system may include a reference member provided on the base member. The hairpin processing system may further include a reference groove provided in the hairpin cartridge and configured to accommodate the reference member.

As described above, according to the embodiment of the present disclosure, the reference member is accommodated in the reference groove when the hairpin cartridge is seated on the base member, such that the displacement of the hairpin cartridge with respect to the base member (displacement in a horizontal direction) may be suppressed. Therefore, it is possible to obtain an advantageous effect of stably maintaining the arrangement state of the hairpin cartridge.

Moreover, in case that the posture and position of the reference groove are misaligned with the reference member, the reference member cannot be accurately inserted into the reference groove, and thus the hairpin cartridge is disposed in an abnormal posture with respect to the base member. Therefore, an operator may easily identify whether the hairpin cartridge is erroneously assembled.

According to an embodiment of the present disclosure, the hairpin processing system may include a hairpin transfer loader configured to transfer the hairpin from the hairpin cartridge to the pre-inserting jig.

According to an embodiment of the present disclosure, the hairpin processing system may include a jig adjustment part configured to selectively change the inner and outer diameters of the pre-inserting jig based on the type of hairpin.

A single common pre-inserting jig is used regardless of the type of hairpin (the size of the hairpin).

In other words, when the type of hairpin is changed, the pre-inserting jig may be adjusted to have the inner and outer diameters correspond to the type of hairpin. According to the embodiment of the present disclosure, the jig adjustment part may selectively change the inner and outer diameters of the pre-inserting jig, making it possible to process different types of hairpins without having to change pre-inserting jigs in accordance with the type of hairpin.

The jig adjustment part may have various structures capable of selectively changing the inner and outer diameters of the pre-inserting jig.

According to an embodiment of the present disclosure, the jig adjustment part may include an inner diameter guide configured to support an inner diameter of the pre-inserting jig. The jig adjustment part may also include an outer diameter guide configured to guide an outer diameter of the pre-inserting jig.

According to an embodiment of the present disclosure, the hairpin cartridge may be provided as a plurality of hairpin cartridges on the alignment part.

According to an embodiment of the present disclosure, the plurality of hairpin cartridges may be disposed side by side with the transfer part interposed therebetween.

According to another embodiment of the present disclosure, the plurality of hairpin cartridges may be provided on the alignment part and disposed in series on a straight line along the transfer part.

### BRIEF DESCRIPTION OF THE DRAWINGS

Since these drawings are for reference in explaining embodiments of the present disclosure, the technical idea of the present disclosure should not be construed as limited to the accompanying drawings.

FIG. 1 is a perspective view illustrating a hairpin processing system according to an embodiment of the present disclosure.

FIG. 2 is a view illustrating a hairpin cartridge of the hairpin processing system according to an embodiment of the present disclosure.

FIG. 3 is a view illustrating a reference member and a reference groove of the hairpin processing system according to an embodiment of the present disclosure.

FIG. 4 is a view illustrating a jig adjustment part of the hairpin processing system according to an embodiment of the present disclosure.

FIG. 5 is a view illustrating a hairpin transfer loader of the hairpin processing system according to an embodiment of the present disclosure.

FIGS. 6 and 7 are views illustrating a modified example of the hairpin processing system according to another embodiment of the present disclosure.

### DETAILED DESCRIPTION

Hereinafter, embodiments of the present disclosure are described in detail with reference to the accompanying drawings.

However, the technical spirit of the present disclosure is not limited to some embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by those having ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected’, ‘coupled’, or ‘attached’ to another constituent element, one constituent element may be connected, coupled, or attached directly to another constituent element or connected, coupled, or attached to another constituent element through still another constituent element interposed therebetween.

When a component, device, element, or the like of the present disclosure is described as having a purpose or performing an operation, function, or the like, the component, device, or element should be considered herein as being “configured to” meet that purpose or perform that operation or function.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

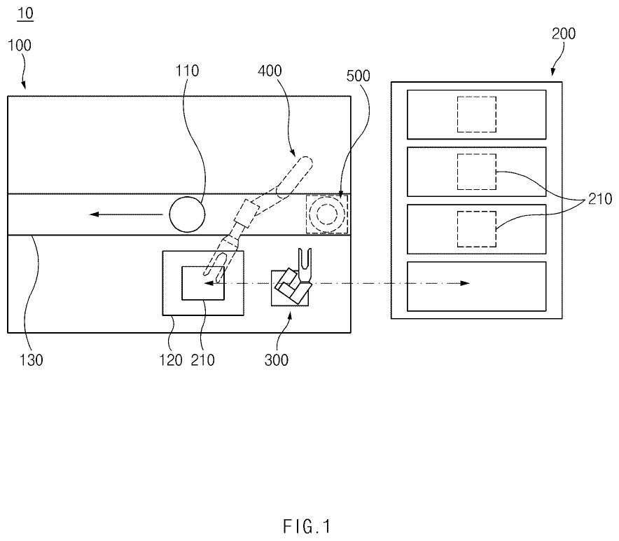

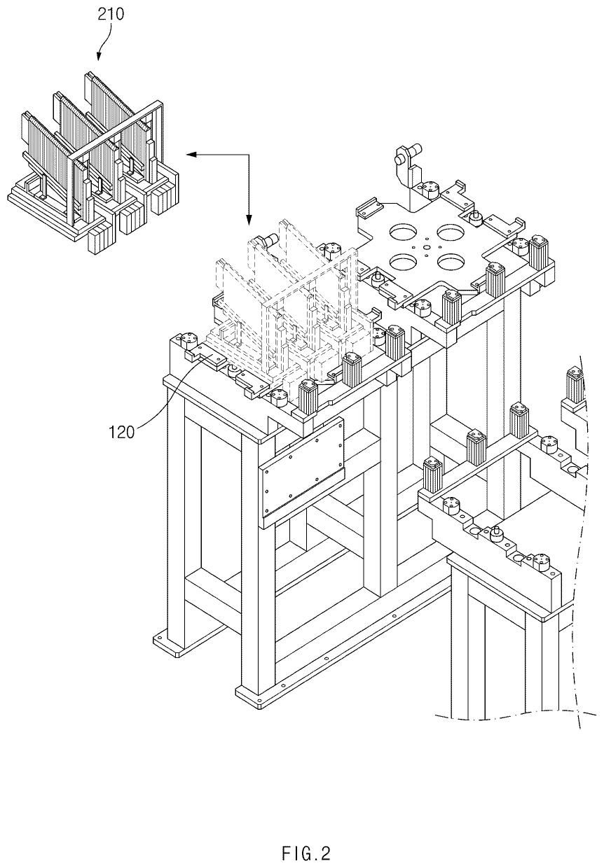

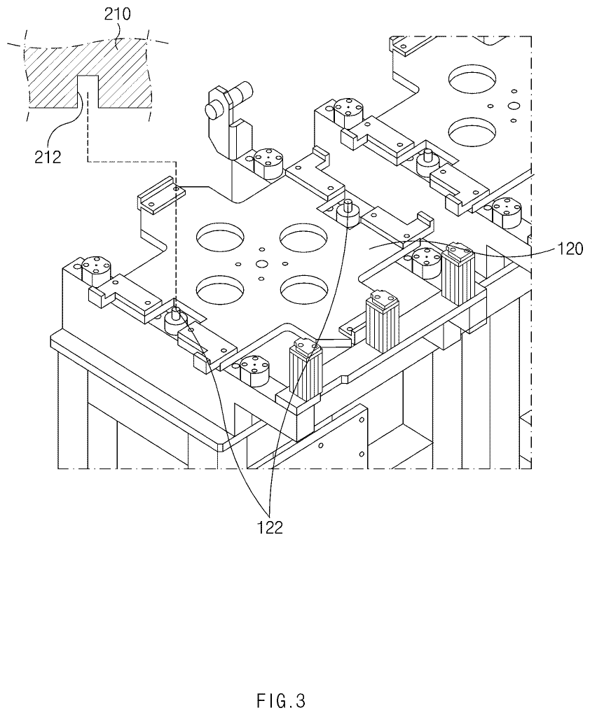

With reference to FIGS. 1 to 7, a system for processing a hairpin (e.g., a hairpin processing system) 10 according to an embodiment of the present disclosure includes an alignment part 100 having a pre-inserting jig 110 configured to perform a pre-inserting (pre-alignment) process on a hairpin 20. The hairpin processing system 10 also includes a cartridge stock 200 configured to store a plurality of different hairpin cartridges 210. A hairpin cartridge 210 of the hairpin cartridges 210 is configured to supply a hairpin 20 to the pre-inserting jig 110. The hairpin processing system 10 further includes a cartridge transfer loader 300 configured to selectively transfer a hairpin cartridge 210 from the cartridge stock 200 to the alignment part 100.

The hairpin processing system 10 according to the embodiment of the present disclosure may be used to process the hairpin (also called a flat coil or an angular copper wire) 20 used as a stator coil for a motor (perform the pre-inserting process on the hairpin). The present disclosure is not restricted or limited by the type and structure of the motor to which the hairpin 20 is applied.

For example, the motor, to which the hairpin 20 is applied, may be used as a drive motor for an environmentally-friendly vehicle, such as a hybrid vehicle and/or an electric vehicle (EV), which obtains driving power from electrical energy.

Hereinafter, an example is described in which the hairpin processing system 10 according to the embodiment of the present disclosure transfers the hairpin 20, which is supplied from the hairpin cartridge 210, to the pre-inserting jig 110, and performs the pre-inserting process before inserting the hairpin 20 into a stator core (not illustrated).

For reference, the hairpin 20 may have various structures in accordance with the required conditions and design specifications. The present disclosure is not restricted or limited by the structure and shape of the hairpin 20.

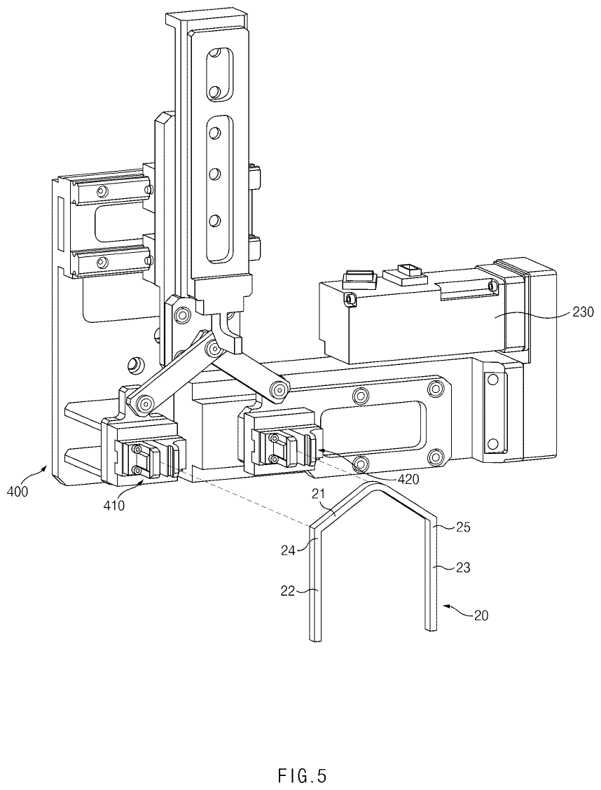

For example, with reference to FIG. 5, the hairpin 20 may have an approximately “U” shape, including a crown portion 21, a first leg portion 22 connected to one end of the crown portion 21, and a second leg portion 23 connected to the other end of the crown portion 21.

For reference, in the embodiment of the present disclosure illustrated and described above, the example has been described in which the hairpin processing system 10 handles the hairpin 20 having an approximately “U” shape. However, according to another embodiment of the present disclosure, the hairpin processing system may handle a hairpin having an approximately “I” shape.

With reference to FIG. 1, the alignment part 100 is provided to perform the pre-inserting (pre-alignment) process on the hairpin 20.

The alignment part 100 may have various structures capable of performing the pre-inserting process on the hairpin 20. The present disclosure is not restricted or limited by the structure and layout of the alignment part 100.

For reference, in the embodiment of the present disclosure, the pre-inserting of the hairpin 20 may be defined as a process of aligning the hairpin 20 at an exact position (target position) and in an exact posture by transferring the hairpin 20 to the pre-inserting jig 110 and inserting the hairpin 20 into the pre-inserting jig 110 before inserting the hairpin 20, which is supplied to the hairpin supply cartridge, into a slot (not illustrated) of the stator core.

More specifically, the alignment part 100 may have the pre-inserting jig 110. Before the hairpin 20 is inserted into the slot of the stator core, the hairpin 20 may be transferred to the pre-inserting jig 110, and the pre-inserting process may be performed on the hairpin 20.

The pre-inserting jig 110 may have various structures having a plurality of alignment grooves (not illustrated) corresponding to slots of the stator core. The present disclosure is not restricted or limited by the structure and shape of the pre-inserting jig 110.

For example, the pre-inserting jig 110 may have an approximately hollow cylindrical shape having a size (diameter) corresponding to a core of the stator.

According to an embodiment of the present disclosure, the alignment part 100 may include a transfer part 130 configured to transfer the pre-inserting jig 110 along a preset route.

The transfer part 130 is provided to selectively load the pre-inserting jig 110 into the alignment part 100 or unload the pre-inserting jig 110 from the alignment part 100. In other words, the pre-inserting jig 110 may move along the route defined by the transfer part 130 and be loaded (inputted) into the alignment part 100 (pre-inserting process position) or unloaded (discharged) to the outside of the alignment part 100.

For example, the transfer part 130 may be provided to define a straight movement route. The pre-inserting jig 110 may move along the straight movement route defined by the transfer part 130. According to another embodiment of the present disclosure, the pre-inserting jig may be configured to move along a curved movement route defined by the transfer part.

The transfer part 130 may have various structures capable of transferring the pre-inserting jig 110. The present disclosure is not restricted or limited by the type and structure of the transfer part 130.

For example, a typical conveyor (e.g., a conveyor belt or a conveyor roller) or a shuttle may be used as the transfer part 130.

The cartridge stock 200 is provided to store the plurality of different hairpin cartridges 210. A hairpin cartridge of the plurality of different hairpin cartridges 210 is configured to supply the hairpin 20 to the pre-inserting jig 110.

The cartridge stock 200 may have various structures capable of storing the plurality of hairpin cartridges 210. The present disclosure is not restricted or limited by the structure and layout of the cartridge stock 200.

In addition, the hairpin cartridge 210, which is stored in the cartridge stock 200, may be variously changed in types and number in accordance with required conditions and design specifications. The present disclosure is not restricted or limited by the type of hairpin cartridge 210 and the number of hairpin cartridges 210.

For example, the cartridge stock 200 may have a plurality of storage regions in which the hairpin cartridges 210 are independently stored, and a buffer region for loading or unloading a hairpin cartridge 210. Hereinafter, an example is described in which three storage regions and a single buffer region are defined in the cartridge stock 200. According to another embodiment of the present disclosure, the cartridge stock may have two or fewer storage regions or four or more storage regions.

Further, the cartridge stock 200 may have a cartridge loader (not illustrated) configured to transfer the hairpin cartridge 210 from the storage region to the buffer region (or from the buffer region to the storage region).

In another embodiment, the hairpin cartridge 210 may include a plurality of hairpins 20.

For reference, the plurality of hairpins 20, which has been formed by a hairpin forming machine, may be loaded into a magazine (not illustrated) and then loaded (inputted) into the hairpin cartridge 210. The hairpin cartridge 210 may be configured to temporarily load and align the plurality of hairpins 20 loaded into the hairpin cartridge 210 (align the plurality of hairpins 20 in postures in which the plurality of hairpins 20 may be picked up one by one).

The hairpin cartridge 210 may have various structures capable of allowing the plurality of hairpins 20 to be picked up one by one. The present disclosure is not restricted or limited by the type and structure of the hairpin cartridge 210. For example, the hairpin cartridge 210 may include a loading part (not illustrated) configured to load the plurality of hairpins 20, and a lifting part (not illustrated) configured to lift the hairpins 20 one by one.

In particular, the plurality of hairpin cartridges 210 may be configured to supply different types of hairpins 20 to the pre-inserting jig 110.

In this case, the configuration in which the plurality of hairpin cartridges 210 supply different types of hairpins 20 to the pre-inserting jig 110 is defined as a configuration in which the hairpin cartridges 210 are responsible for handling hairpins 20 with different dimensions (e.g., different widths of the first and second leg portions) and supply the hairpins 20 to the pre-inserting jig 110.

With reference to FIGS. 1 to 3, according to another embodiment of the present disclosure, the hairpin processing system 10 may include a base member 120 provided on the alignment part 100. The hairpin cartridge 210 may be seated on the base member 120.

The base member 120 may have various structures capable of allowing the hairpin cartridge 210 to be seated (mounted) thereon. The present disclosure is not restricted or limited by the structure and shape of the base member 120. For example, the base member 120 may be provided in the form of a kind of quadrangular table (cradle). A seating portion, on which the hairpin cartridge 210 is seated, may be defined on an upper surface of the base member 120.

According to the embodiment of the present disclosure, the hairpin processing system 10 may include reference members 122 provided on the base member 120. The hairpin processing system 10 may also include reference grooves 212 provided in the hairpin cartridge 210 (e.g., provided in a bottom surface of the hairpin cartridge) and configured to accommodate the reference members 122.

For example, the reference member 122 may be provided in the form of a pin having a circular cross-section. The reference groove 212 may be provided in the form of a circular groove corresponding to the reference member 122. According to another embodiment of the present disclosure, the reference member 122 may have a polygonal (e.g., quadrangular) cross-sectional shape or other cross-sectional shapes.

As described above, according to the embodiment of the present disclosure, the reference member 122 is accommodated in the reference groove 212 when the hairpin cartridge 210 is seated on the base member 120, such that the displacement of the hairpin cartridge 210 with respect to the base member 120 (displacement in a horizontal direction) may be suppressed. Therefore, it is possible to obtain an advantageous outcome of stably maintaining the arrangement state of the hairpin cartridge 210.

Moreover, in case that the posture and position of the reference groove 212 are misaligned with the reference member 122, the reference member 122 cannot be accurately inserted into the reference groove 212. As a result, the hairpin cartridge 210 is disposed in an abnormal posture with respect to the base member 120. Therefore, an operator may easily identify whether the hairpin cartridge 210 is erroneously assembled.

In the embodiment of the present disclosure illustrated and described above, an example has been described in which the reference member 122 is provided on the base member 120 and the reference groove 212 is provided in the hairpin cartridge 210. However, according to another embodiment of the present disclosure, the reference member 122 may be provided on the hairpin cartridge 210, and the reference groove 212 may be provided in the base member 120.

The cartridge transfer loader 300 is provided to selectively transfer the hairpin cartridge 210 from the cartridge stock 200 to the alignment part 100 (or from the alignment part to the cartridge stock).

The cartridge transfer loader 300 may have various structures capable of transferring the hairpin cartridge 210. The present disclosure is not restricted or limited by the type and structure of the cartridge transfer loader 300.

For example, a typical carrier or robot may be used as the cartridge transfer loader 300.

Further, the movement route for the cartridge transfer loader 300 may be variously changed in accordance with the required conditions and design specifications. The present disclosure is not restricted or limited by the movement route for the cartridge transfer loader 300. Hereinafter, an example is described in which the cartridge transfer loader 300 is configured to move along a straight movement route.

With the above-mentioned structure, the cartridge transfer loader 300 may extract the hairpin cartridge 210, which is designed for the desired type of hairpin 20, from the cartridge stock 200 and then load the hairpin cartridge 210 into the alignment part. In addition, another hairpin cartridge 210, which has been previously loaded into the alignment part, may be transferred to the buffer region by the cartridge transfer loader 300 and then transferred to the storage region by the cartridge loader.

With reference to FIGS. 1 and 5, according to the embodiment of the present disclosure, the hairpin processing system 10 may include a hairpin transfer loader 400 configured to transfer each hairpin 20 from the hairpin cartridge 210 to the pre-inserting jig 110.

A typical robot or carrier capable of gripping and transferring the hairpins 20, which are loaded into the hairpin cartridge 210, one by one, may be used as the hairpin transfer loader 400. The present disclosure is not restricted or limited by the type and structure of the hairpin transfer loader 400.

According to the embodiment of the present disclosure, the hairpin transfer loader 400 may be configured to grip a hairpin 20 regardless of the type of hairpin 20 (the size of the hairpin).

For example, the hairpin transfer loader 400 may include a first finger grip part 410 configured to grip (e.g., finger-grip) a first portion 24 of the hairpin 20, and a second finger grip part 420 configured to grip (e.g., finger-grip) a second portion 25 of the hairpin 20 independently of the first finger grip part 410.

For reference, in the embodiment of the present disclosure, the configuration in which the first finger grip part 410 and the second finger grip part 420 finger-grip the hairpin 20 may be defined as a configuration in which the first finger grip part 410 and the second finger grip part 420 grip the hairpin 20 as if two fingers grasp the first finger grip part 410 and the second finger grip part 420.

For example, the first finger grip part 410 may include a first finger member (not illustrated), and a second finger member (not illustrated) configured to be movable in a direction in which the second finger member moves toward or away from the first finger member such that the first finger member and the second finger member collectively grip the hairpin 20. The hairpin 20 may be gripped (clamped) between the first finger member and the second finger member of the first finger grip part 410.

The second finger grip part 420 may also include a first finger member (not illustrated), and a second finger member (not illustrated) configured to be movable in a direction in which the second finger member moves toward or away from the first finger member such that the first finger member and the second finger member collectively grip the hairpin 20. The hairpin 20 may be gripped (clamped) between the first finger member and the second finger member of the second finger grip part 420.

In particular, the first finger grip part 410 may be configured to grip a boundary (soldered portion 24) between the crown portion 21 and the first leg portion 22, and the second finger grip part 420 may be configured to grip a boundary (soldered portion 25) between the crown portion 21 and the second leg portion 23. This is described further below.

Process methods, such as Numerical Control (NC) bending and pressing, are used to manufacture the hairpin 20 from a straight coil. In this case, the forming quality of the boundary (soldered portion) between the crown portion 21 and the leg portion (the first leg portion 22 and the second leg portion 23) is high (forming deviation is small). However, the leg portion (the first leg portion 22 or the second leg portion 23), which serves as a criterion for the insertion of the pre-inserting jig 110, experiences an increasing degree of dimension dispersion toward the end thereof because of spring back and thus is easily deformed.

According to the embodiment of the present disclosure described above, the first finger grip part 410 is configured to grip the boundary (soldered portion) between the crown portion 21 and the first leg portion 22 at which the forming deviation is the smallest in the hairpin 20. Additionally, the second finger grip part 420 is configured to grip the boundary (soldered portion) between the crown portion 21 and the second leg portion 23 at which the forming deviation is also the smallest in the hairpin 20. Therefore, it is possible to obtain an advantageous effect of further improving the gripping stability of the first finger grip part 410 and the second finger grip part 420.

According to the embodiment of the present disclosure, the second finger grip part 420 may be provided to be selectively movable rectilinearly in a direction in which the second finger grip part 420 moves toward or away from the first finger grip part 410.

This is to handle (grip and transfer) the hairpins 20 having various sizes regardless of the type of hairpin 20.

In other words, the dimensions of the hairpin 20 (e.g., the widths of the first and second leg portions) may be variously changed in accordance with required conditions and design specifications. In the embodiment of the present disclosure, the second finger grip part 420 rectilinearly moves relative to the first finger grip part 410 (i.e., the second finger grip part 420 rectilinearly moves in the direction in which the second finger grip part 420 moves toward or away from the first finger grip part 410) based on the size of the hairpin 20. Therefore, it is possible to handle (grip) the hairpins 20 having various sizes without changing the hairpin transfer loaders 400.

In case that the hairpin processing system 10 handles only the hairpin having an approximately “I” shape, only one of the first and second finger grip parts 410 and 420 may be used to grip the hairpin.

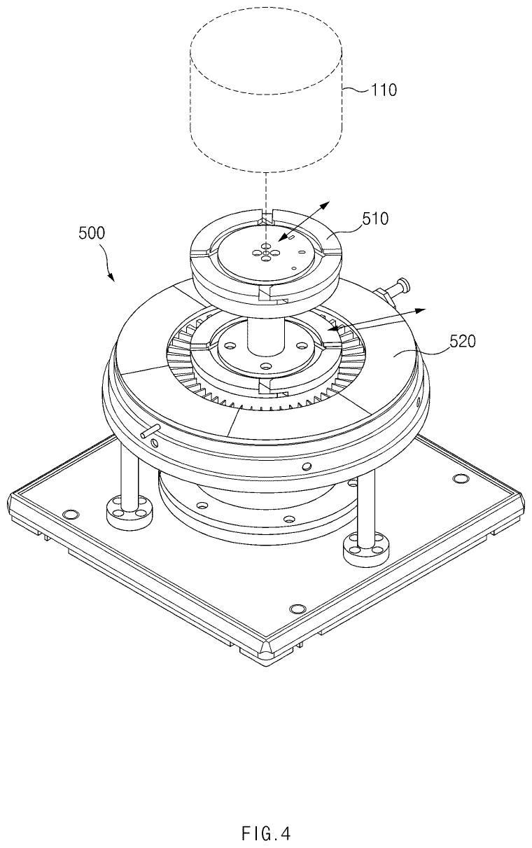

With reference to FIGS. 1 and 4, according to the embodiment of the present disclosure, the hairpin processing system 10 may include a jig adjustment part 500 configured to selectively change the inner and outer diameters of the pre-inserting jig 110 based on the type of hairpin 20.

Therefore, a single common pre-inserting jig 110 is used regardless of the type of hairpin 20 (the size of the hairpin).

In other words, when the type of hairpin 20 is changed, the pre-inserting jig 110 may be adjusted to have the inner and outer diameters correspond to the type of hairpin 20. According to the embodiment of the present disclosure, the jig adjustment part 500 may selectively change the inner and outer diameters of the pre-inserting jig 110, thus making it possible to process different types of hairpins 20 without having to change the pre-inserting jig 110 in accordance with the type of hairpin 20.

The jig adjustment part 500 may have various structures capable of selectively changing the inner and outer diameters of the pre-inserting jig 110. The present disclosure is not restricted or limited by the type and structure of the jig adjustment part 500.

With reference to FIG. 4, according to an embodiment of the present disclosure, the jig adjustment part 500 may include an inner diameter guide 510 configured to support the inner diameter (inner peripheral surface) of the pre-inserting jig 110. The jig adjustment part 500 may also include an outer diameter guide 520 configured to guide the outer diameter (outer peripheral surface) of the pre-inserting jig 110.

The inner diameter guide 510 may be provided to be expandable and contractible in a radial direction of the pre-inserting jig 110 and support (come into surface contact with) the inner peripheral surface of the pre-inserting jig 110. The outer diameter guide 520 may be provided to be expandable and contractible in the radial direction of the pre-inserting jig 110 and support (come into surface contact with) the outer peripheral surface of the pre-inserting jig 110.

For example, the inner diameter guide 510 may include a plurality of first arc guide parts (not illustrated) provided to be rectilinearly movable in the radial direction of the pre-inserting jig 110 and configured to collectively support the inner peripheral surface of the pre-inserting jig 110. The outer diameter guide 520 may include a plurality of second arc guide parts (not illustrated) provided to be rectilinearly movable in the radial direction of the pre-inserting jig 110 and configured to collectively support the outer peripheral surface of the pre-inserting jig 110.

In the embodiments of the present disclosure illustrated and described above, the example has been described in which the alignment part 100 has only the single hairpin cartridge 210. However, according to another embodiment of the present disclosure, the plurality of hairpin cartridges 210 may be provided on the alignment part 100.

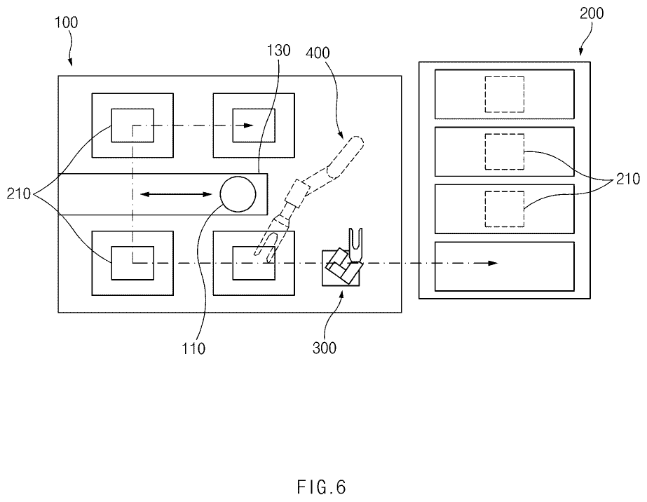

With reference to FIG. 6, according to the embodiment of the present disclosure, the plurality of hairpin cartridges 210 that may be disposed on the alignment part 100 is provided in parallel and side by side with the transfer part 130 interposed therebetween.

Further, the cartridge transfer loader 300 may extract the hairpin cartridge 210, which is suitable for a desired type of hairpin 20, from the cartridge stock 200 and then load the hairpin cartridge 210 into the alignment part while moving along an approximately “U”-shaped route.

In addition, only the single hairpin transfer loader 400 may be provided on the alignment part 100. The hairpin transfer loader 400 may transfer each hairpin 20, which is loaded into the hairpin cartridge 210, to the pre-inserting jig 110 loaded by the transfer part 130.

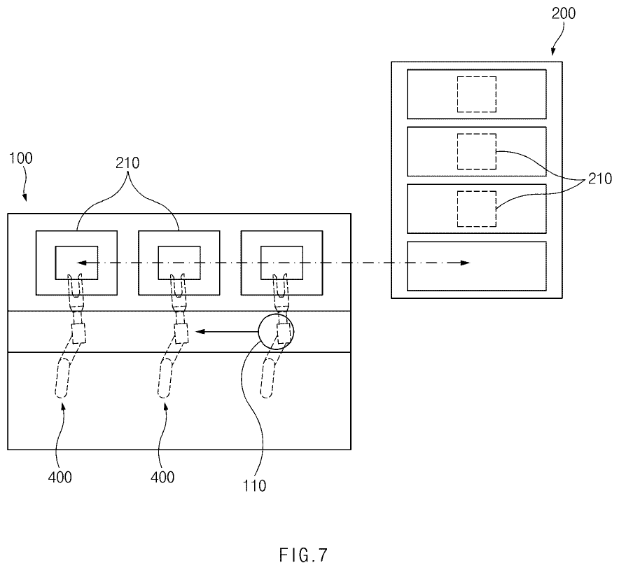

As illustrated in FIG. 7, according to another embodiment of the present disclosure, the plurality of hairpin cartridges 210 may be provided on the alignment part 100 and disposed in series on a straight line along the transfer part 130.

Further, the cartridge transfer loader 300 may extract the hairpin cartridge 210, which is suitable for the desired type of hairpin 20, from the cartridge stock 200 and then load the hairpin cartridge 210 into the alignment part while moving along an approximately straight route.

In addition, a plurality of hairpin transfer loaders 400 may be provided on the alignment part 100 so as to correspond to the hairpin cartridges 210. The hairpin transfer loader 400 may transfer each hairpin 20, which is loaded into the corresponding hairpin cartridge 210, to the pre-inserting jig 110 loaded by the transfer part 130.

According to the embodiment of the present disclosure described above, the plurality of hairpin cartridges 210 is provided on the alignment part 100. Therefore, it is possible to obtain an advantageous effect of improving the productivity and production efficiency and improving the efficiency in processing the hairpin 20.

According to the embodiment of the present disclosure described above, it is possible to obtain an advantageous effect of simplifying the structure and treatment process and improving the productivity and production efficiency.

In particular, according to the embodiment of the present disclosure, it is possible to obtain an advantageous effect of handling various types of hairpins without additional facilities and production lines.

Among other things, according to the embodiment of the present disclosure, it is possible to process different types of hairpins by selectively changing the hairpin cartridges in the single production line.

In addition, according to the embodiment of the present disclosure, it is possible to obtain an advantageous effect of improving the efficiency of the pre-inserting process for the hairpin, shortening the amount of time required to perform the pre-inserting process on the hairpin, and improving the production quality.

While the embodiments have been described above, the embodiments are just illustrative and not intended to limit the present disclosure. It can be appreciated by those having ordinary skill in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and applications are included in the scope of the present disclosure defined by the appended claims.

What is claimed is:

1. A system for processing a hairpin for a stator, the system comprising:
an alignment part including a pre-inserting jig configured to perform a pre-inserting process on a hairpin;
a cartridge stock configured to store a plurality of different hairpin cartridges, wherein a hairpin cartridge of the plurality of different hairpin cartridges is configured to supply the hairpin to the pre-inserting jig; and
a cartridge transfer loader configured to selectively transfer the hairpin cartridge from the cartridge stock to the alignment part.

2. The system of claim 1, wherein the plurality of different hairpin cartridges is configured to supply different types of hairpins to the pre-inserting jig.

3. The system of claim 1, further comprising:
a base member provided on the alignment part,
wherein the hairpin cartridge is seated on the base member.

4. The system of claim 3, further comprising:
a reference member provided on the base member; and
a reference groove provided in the hairpin cartridge and configured to accommodate the reference member.

5. The system of claim 1, further comprising:
a hairpin transfer loader configured to transfer the hairpin from the hairpin cartridge to the pre-inserting jig.

6. The system of claim 1, further comprising:
a jig adjustment part configured to selectively change inner and outer diameters of the pre-inserting jig based on a type of hairpin.

7. The system of claim 6, wherein the jig adjustment part comprises:
an inner diameter guide configured to support an inner diameter of the pre-inserting jig; and
an outer diameter guide configured to guide an outer diameter of the pre-inserting jig.

8. The system of claim 1, further comprising:
a transfer part provided on the alignment part and configured to transfer the pre-inserting jig along a preset route.

9. The system of claim 8, wherein the plurality of different hairpin cartridges are provided on the alignment part.

10. The system of claim 9, wherein the plurality of different hairpin cartridges is provided on a straight line along the transfer part.

11. The system of claim 9, wherein the plurality of different hairpin cartridges is provided side by side with the transfer part interposed therebetween.
